(19) United States
(12) Patent Application Publication
(10) Pub. No.: US 2011/0175432 A1
(43) Pub. Date: Jul. 21, 2011

(54) Integration of ballistic resistant materials into a wheel

(75) Inventors: Larry K. Rogers, Bordentown, NJ (US); Pascal Seradarian, Princeton Jct., NJ (US)

(73) Assignee: Hutchinson, S.A.

(21) Appl. No.: 11/787,997

(22) Filed: Apr. 18, 2007

Related U.S. Application Data
(60) Provisional application No. 60/901,794, filed on Feb. 16, 2007.

(51) Int. Cl. B60B 3/00

(52) U.S. Cl. 301/62

(57) ABSTRACT

In this invention ballistic resistant materials are integrated into a wheel for protection of the Tire Bead Bundle, protection of hardware, and protection of hub components. The Tire Bead Bundle can be protected by supplementing the existing rim flange with ballistic resistant material and/or by placing such material between the flange and the bead bundle. Further, for protection of hardware (including Manual Inflation or CTI Valves), ballistic resistant material can be incorporated over or on wheel hardware. Finally, ballistic resistant materials can be incorporated over or on the wheel hub diameter to reduce the risk of damage due to ballistic attacks.

### CROSS-REFERENCE TO RELATED APPLICATIONS

This application claims an invention which was disclosed in a provisional application filed Feb. 16, 2007, Ser. No. 60/901,794, entitled “Integration of a Ballistic Resistant Materials into a Wheel”. The benefit under 35 USC §119(e) of the United States provisional application is hereby claimed, and the aforementioned application is hereby incorporated herein by reference.

### BACKGROUND AND SUMMARY

Our invention pertains to the integration of ballistic resistant materials and functionality into a wheel. More particularly, this invention describes means for attachment or inclusion of ballistic resistant materials to/in the wheel for protection of the bead bundle of the tire on the wheel, the wheel itself, and vulnerable sections of the vehicle hub, brake, axle, and so forth.

FIGS. 1 and 2 provide background on the structure of typical wheel and tire assemblies. More specifically, FIG. 1 shows a section of a one-piece wheel assembly 1, while FIG. 2 shows a section of a two-piece wheel assembly 16.

The one-piece wheel assembly 1 of FIG. 1 includes a wheel 2 with tire 3. Parts of wheel include a rim portion 4 and a disc portion 5. The rim portion 4 of the wheel 2 consists of a drop center area 6, flanges 7 and a valve 8. The disc portion 5 of the wheel 2 consists of mounting holes 9 and a hub bore area 10. Parts of a tire 3 include the tire beads 11, the bead bundle 12, the sidewall 13, and the tread area 14. The tire 3 and rim portion 4 form a chamber 15 that contains a pressured fluid (usually air).

The two-piece wheel assembly 16 of FIG. 2 includes a two-piece wheel 17, a tire 3, and a central tire inflation (CTI) valve 18 attached to a two-piece wheel 17. A two-piece wheel 17 consists of an inner rim 19 and an outer rim 20 connected using a stud 21 and nut 22. The tire beads 11 may be secured against the rim flange(s) 7 using a beadlock insert (not shown). The CTI valve 18 uses an airway 23 from the hub (not shown) to the CTI valve 18 and an airway 24 from the CTI valve to the tire cavity. These internal passageways 23 and 24 are patented under U.S. Pat. No. 6,474,383 and European Patent EP 1 262 340 A2. The insert of the wheel, in addition to locking the tire beads 11 against the rim flange(s) 7, may also provide runflat capability when the air chamber 15 is not inflated. The tire 3 may or may not provide limited runflat capability through other methods such as stiff sidewalls.

However, whether a one-piece wheel assembly 1 of the type illustrated in FIG. 1 or a two-piece wheel assembly 16 of the type illustrated in FIG. 2, there is currently no explicit protection in place for ballistic attacks. Wheels are typically made of structural steel or aluminum that, by themselves, provide little to no ballistic resistance. Projectiles can rupture the tire, the rim, the hub, or a combination thereof. To the extent that covers are used on existing wheels, their primary purpose is to protect wheel components (i.e. lug nuts, valves, hub components) from impact damage incurred during vehicle operation. These covers do not provide any protection against ballistic attack.

Thus, although many components of military and security vehicles are protected through various up-armoring technologies, the wheel/tire assembly remains one of the more vulnerable areas to ballistic attack. A rupture of the tire bead bundle can result in complete air loss and possible dislodging of the tire beads from the rim flange. The effects of this failure inhibit the vehicle from moving and possibly escaping life-threatening environments.

This problem of ballistic attack on a wheel/tire assembly is partially solved through the use of a runflat/beadlock insert. By locking the tire beads in place (beadlock/runflat) and providing the tire support, the vehicle is still mobile for a period of time even if air is evacuated from the tire cavity. However, one disadvantage of this method is that no protection is provided for a ballistic attack that damages or destroys the tire bead bundle. If the integrity of the bead bundle is compromised, the beadlock function diminishes and the tire may become dislodged from the wheel rim. If this happens, even runflat/beadlock inserts will not serve to delay the inevitable.

The purpose of this invention is, therefore, to protect the tire bead bundle and components of a wheel assembly and/or vehicle from ballistic damage. Ballistic damage is any damage sustained by the wheel/tire assembly from projectiles including, but not limited to, rifle fire, explosives, and explosive shrapnel. This protection is focused on, but not limited to, the bead bundle of the tire on the wheel, central tire inflation (CTI) valve on or in the wheel, the wheel itself, and vulnerable sections of the vehicle hub, brake, axle, etc. within the envelope of the wheel. This disclosure does not seek to patent the specific materials or coatings, or combination thereof, used to implement this invention, but instead the methodology and embodiments to integrate this concept onto/into a wheel.

The purposes of our invention are primarily fulfilled by integration of ballistic resistant materials into a wheel for protection of the Tire Bead Bundle, protection of hardware, and protection of hub components. First, the Tire Bead Bundle is protected by supplementing the existing rim flange with ballistic resistant material, thereby significantly reducing the possibility of damage to the Tire Bead Bundle. Second, although covers already exist to prevent dislodging of hardware (valves, for example) on the wheel rim or disc during vehicle operation, such covers still leave these components vulnerable to ballistic attack. Thus, for protection of hardware (including Manual Inflation or CTI Valves), we incorporate a ballistic resistant material over or on wheel hardware to reduce risk of damage due to ballistic attacks. Third, although covers already exist to prevent rock, brush or curb damage to wheel and hub components protruding from the wheel face during vehicle operation, they still leave said components vulnerable to ballistic attack. Thus, here we also incorporate a ballistic resistant material over or on the wheel hub diameter to reduce the risk of damage due to ballistic attacks.

### BRIEF DESCRIPTION OF THE DRAWINGS

FIG. 1 provides a perspective partial cross-sectional view of a prior art one-piece wheel assembly.

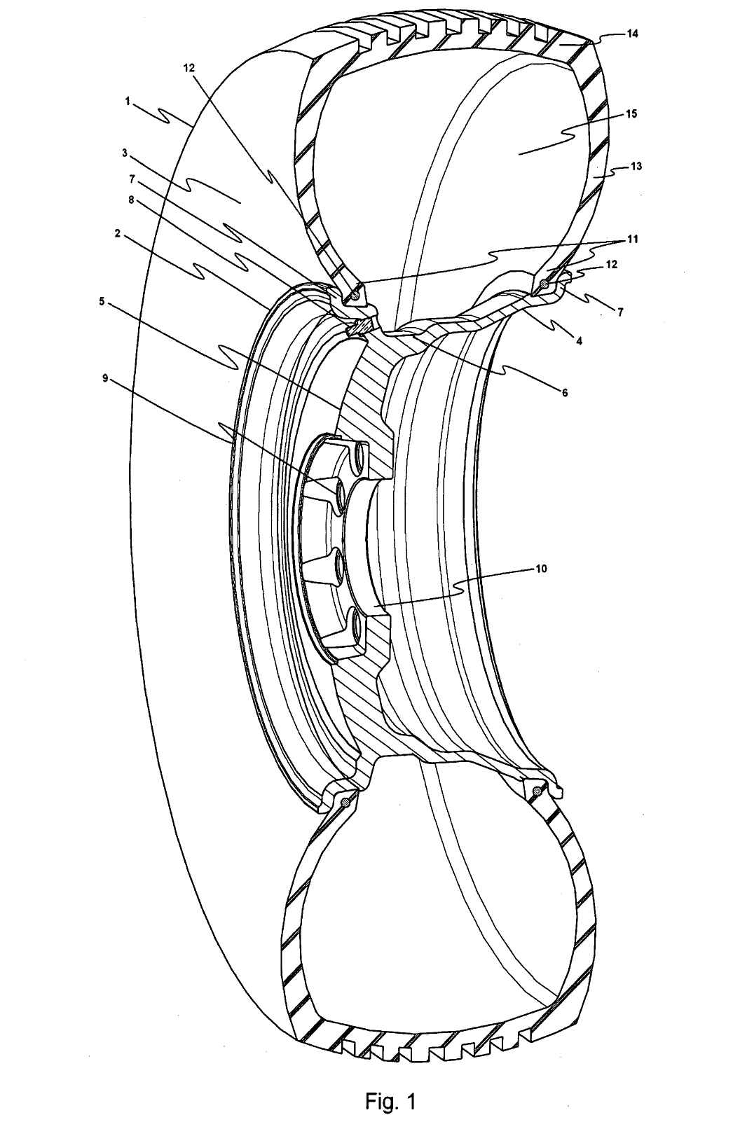

FIG. 2 provides a perspective partial cross-sectional view of a prior art two-piece wheel assembly with externally mounted CTI valve and quick release valve.

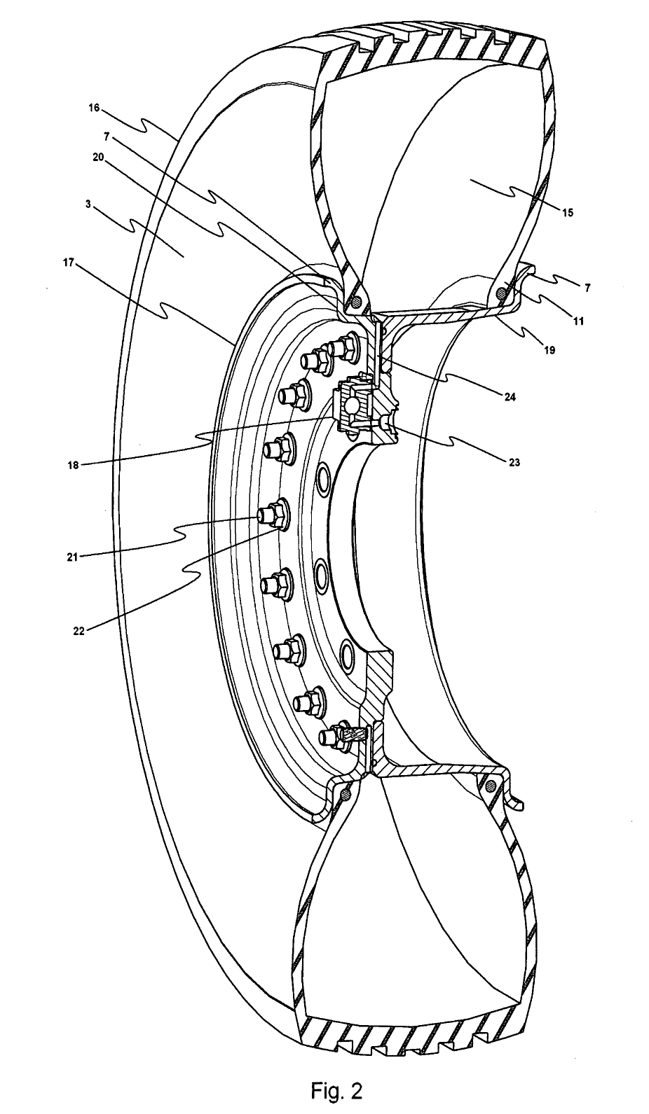

FIG. 3 provides a cross-sectional view of a portion of a two-piece wheel assembly which includes, in accordance with the teachings of our invention, a ballistic resistant material affixed to its rim flange.

FIG. 4 provides a perspective partial cross-sectional view of a two-piece wheel assembly which includes, in accordance with the teachings of our invention, a ballistic resistant material in the form of a ring affixed to its wheel flange.

FIG. 5 provides a cross-sectional view of a portion of a two-piece wheel assembly which includes, in accordance with the teachings of our invention, a modified rim flange partially wrapping around ballistic resistant material.

FIG. 6 provides a cross-sectional view of a portion of a two-piece wheel assembly which includes, in accordance with the teachings of our invention, a modified rim flange partially wrapping around ballistic resistant material.

FIG. 7 provides a perspective partial cross-sectional view of a two-piece wheel assembly which includes, in accordance with the teachings of our invention, a ballistic resistant material in the form of a split ring partially inside its modified rim flange.

FIG. 8 provides a cross-sectional view of a portion of a two-piece wheel assembly which includes, in accordance with the teachings of our invention, ballistic resistant material inside a modified rim flange.

FIG. 9 provides a cross-sectional view of a portion of a two-piece wheel assembly which includes, in accordance with the teachings of our invention, a ballistic resistant fabric interlaced in a rubber material and placed between the bead and the wheel.

FIG. 10 provides a cross-sectional view of a portion of a two-piece wheel assembly which includes, in accordance with the teachings of our invention, a rim flange made from ballistic resistant material.

FIG. 11 provides a cross-sectional view of a portion of a two-piece wheel assembly which includes, in accordance with the teachings of our invention, a ballistic resistant plate mounted to the disc area of the wheel.

FIG. 12 provides a perspective partial cross-sectional view of a two-piece wheel assembly which includes, in accordance with the teachings of our invention, a cover for a CTI Valve formed from a ballistic resistant material.

### DESCRIPTION

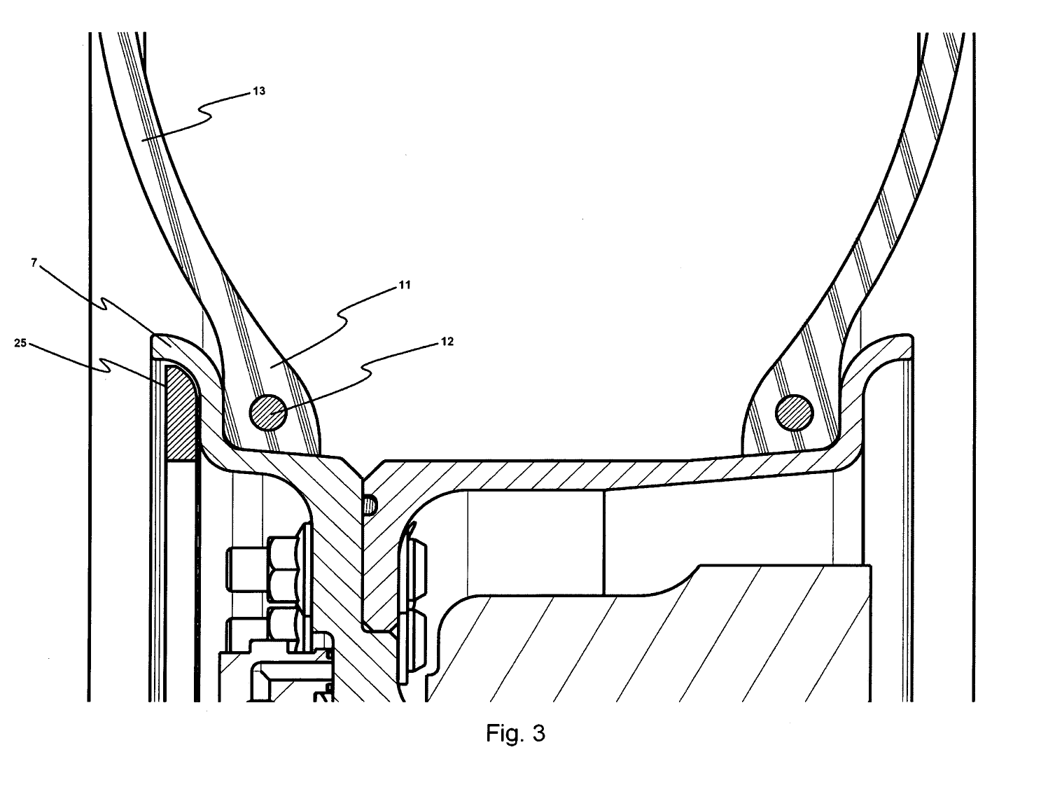

A first mode of implementing of our invention is illustrated in FIG. 3, which shows ballistic resistant material 25 affixed to a standard rim flange 7 such that the bead bundle 12 is better protected from ballistic damage. Ballistic resistant materials are defined as materials, coatings, composites or combinations thereof that are capable of slowing, stopping, fragmenting or deflecting projectiles in motion. This includes, but is not limited to, ballistic grade steel, reactive armor, titanium, composites, spring steels, fibers and fabrics, ceramics, and coatings. (Further and more detailed information on ballistic resistant materials and their normal applications can be acquired from numerous military and industry sources such as, e.g., The AMPTIAC Quarterly, Vol. 8, Number 4 (2004), published by the Advanced Materials and Processes Technology Information Analysis Center (AMPTIAC)).

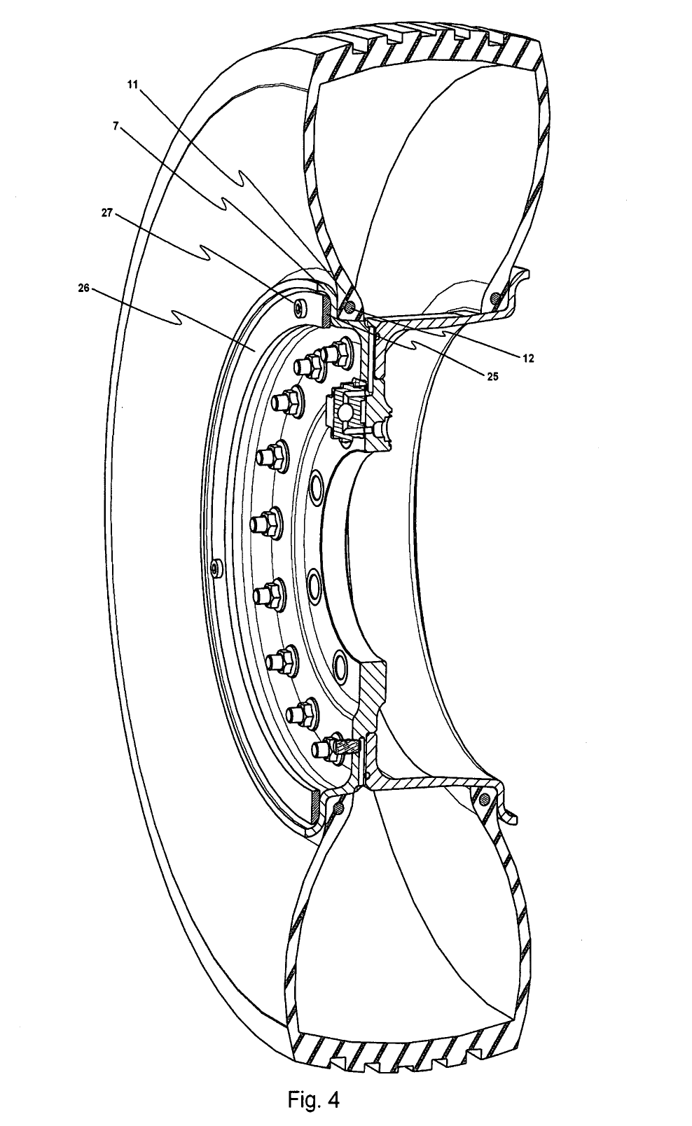

The material 25 can be affixed to the flange 7 using adhesives, mechanical fasteners, clips, pressure, or other means. The form of the ballistic resistant material 25 can be either continuous or in multiple sections to cover the desired area of protection. Thus, FIG. 4 provides an example of ballistic resistant material 25 in the form of a continuous ring 26 affixed to the wheel flange 7 using threaded fasteners 27.

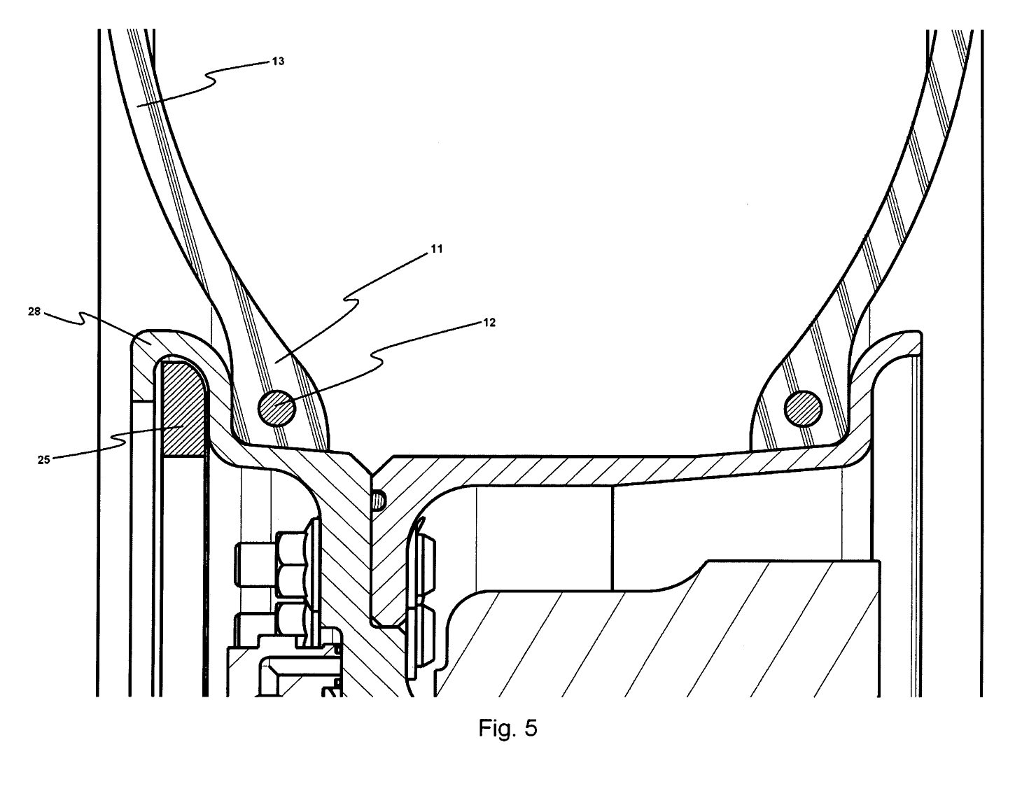

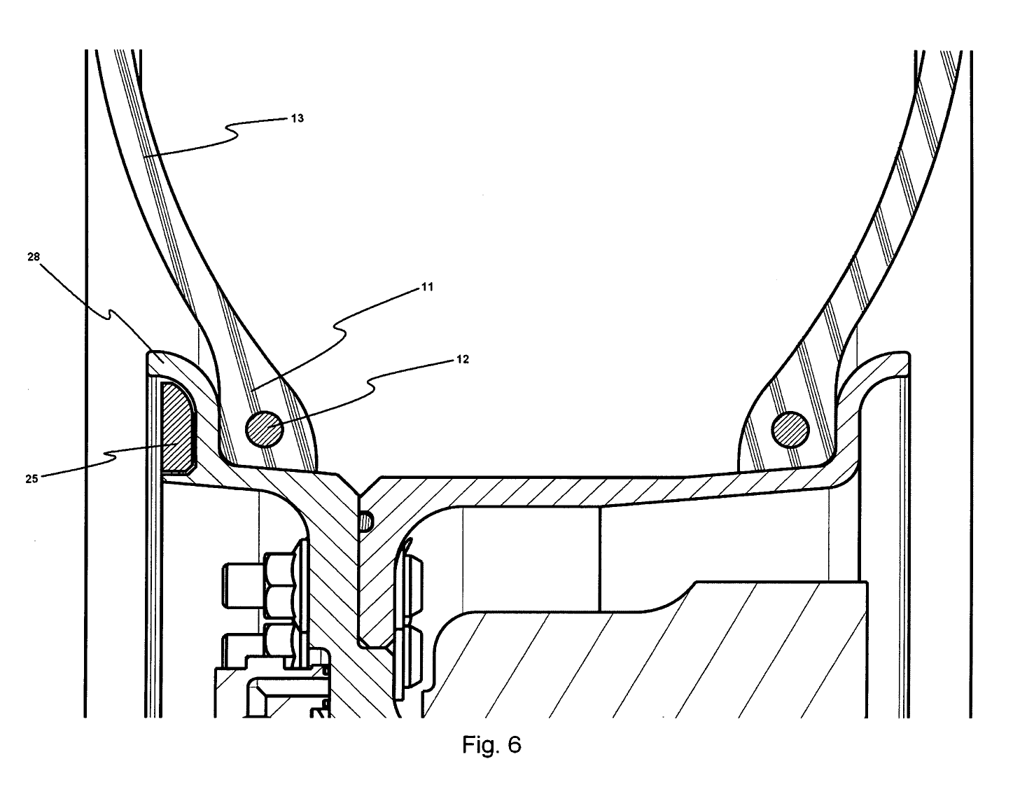

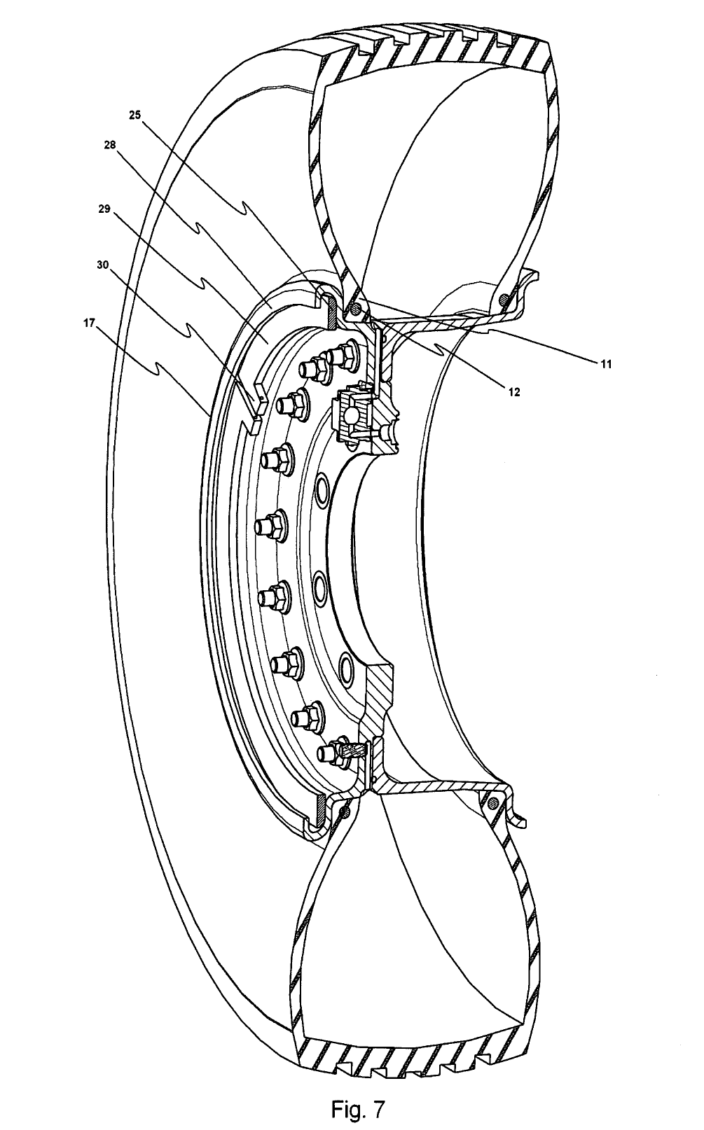

The mode of implementation addressed in FIGS. 3 and 4 is further developed in FIGS. 5, 6 and 7. FIGS. 5 and 6 show two designs for modified rim flanges 28 with extensions that partially wrap around (and hold/brace/contain) the ballistic resistant material 25. As the foregoing makes clear, ballistic resistant material 25 can be partially or fully enclosed by the rim flange 28. Once again, the form of ballistic resistant material 25 partially or fully enclosed by the flange 28 can be either continuous, split, or in multiple sections. The material 25 can be retained in the flange 28 using adhesives, mechanical fasteners, clips, pressure, or other means. FIG. 7 shows the ballistic resistant material 25 in the form of a split ring 29, partially inside the flange 28 of the wheel 17. Here the method of assembly is facilitated by provision of protrusions 30 on the split ring 29 sections that serve to facilitate insertion into the modified rim flange 28 and connection of the split ring 29 sections.

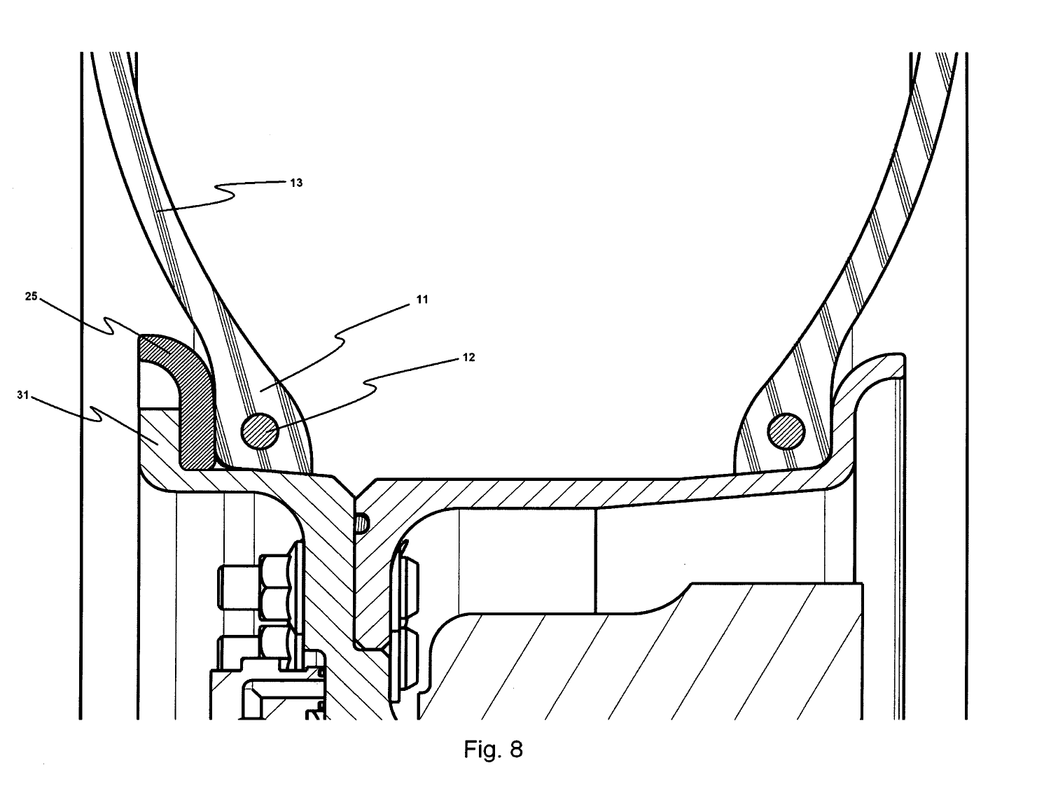

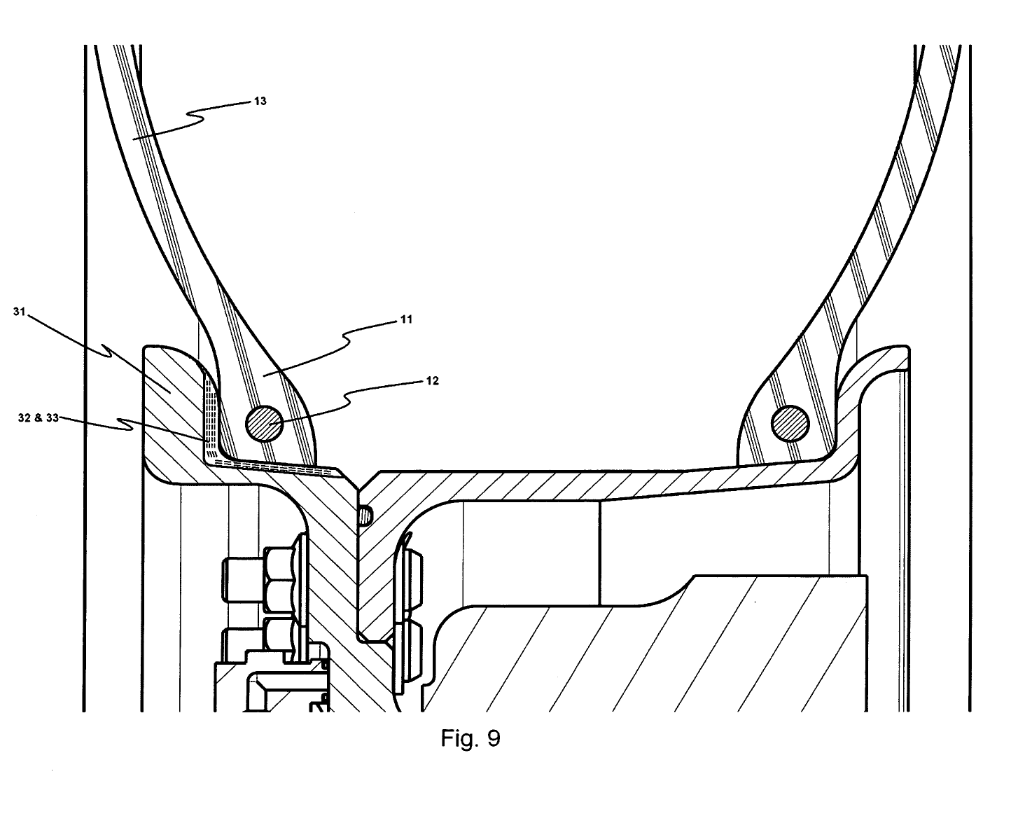

FIGS. 8 and 9 show a somewhat different mode for implementing our invention—placement of the ballistic resistant material between the bead and rim/flange. FIG. 8, for example, shows the ballistic resistant material 25 inside a modified rim flange 31 (on the tire side of the rim flange). FIG. 9, provides another example, illustrating a ballistic resistant fabric 32 interlaced in, e.g., a rubber material 33 between the bead and rim/flange. Here, the nature of the ballistic resistant fabric helps to provide ballistic resistance, while the rubber or other “sealing” material helps to assure an air-tight seal.

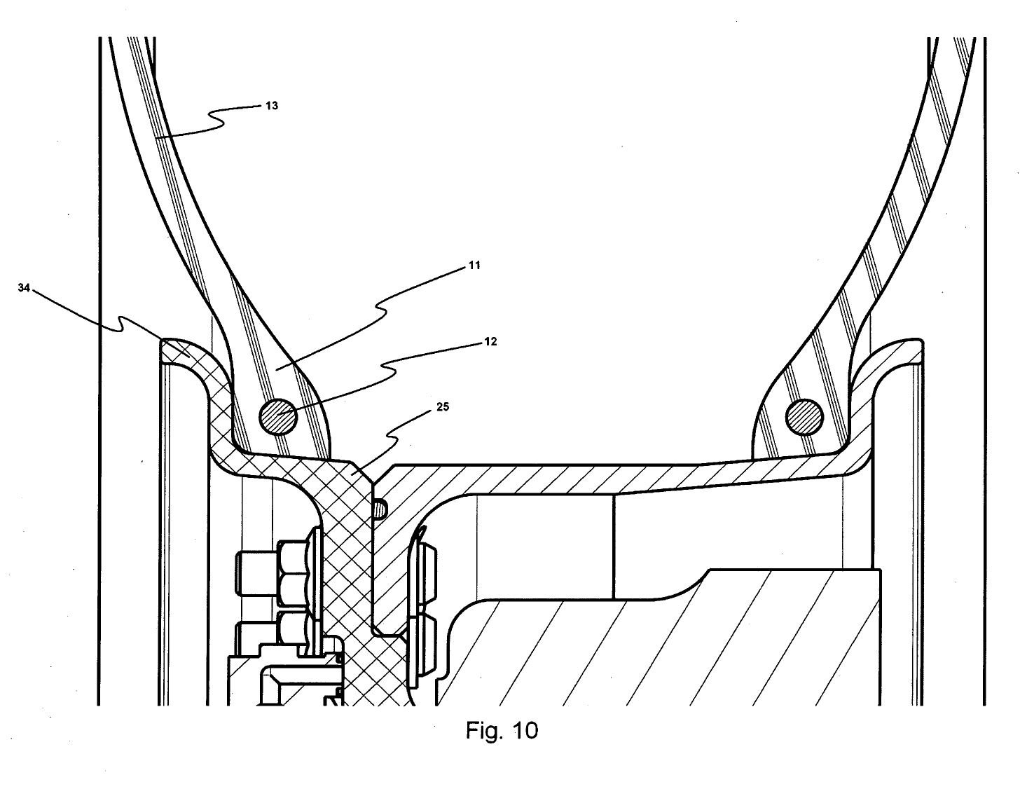

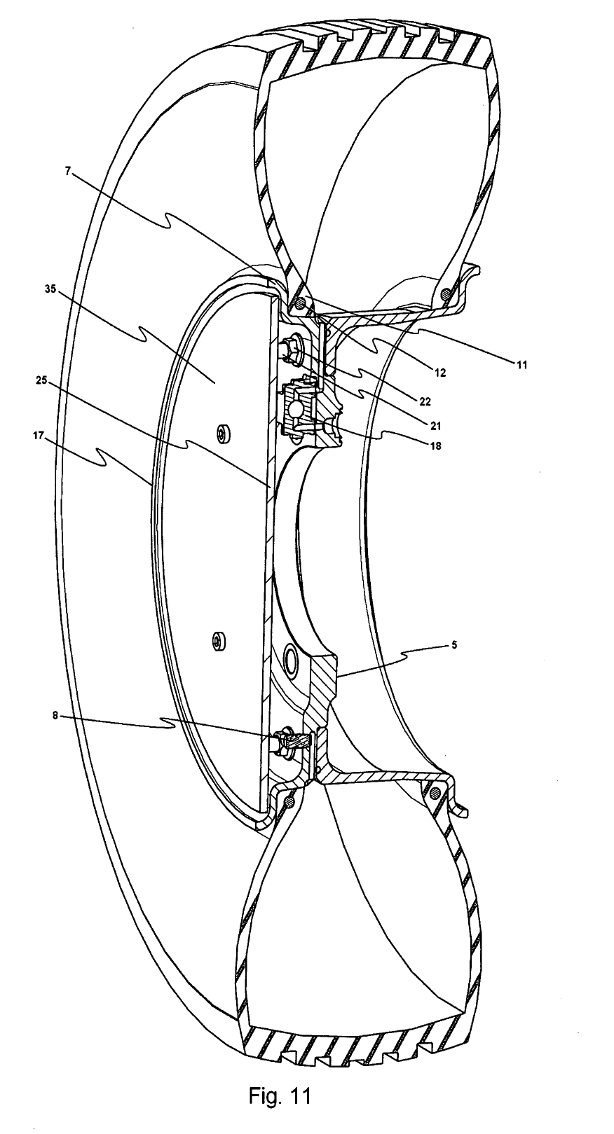

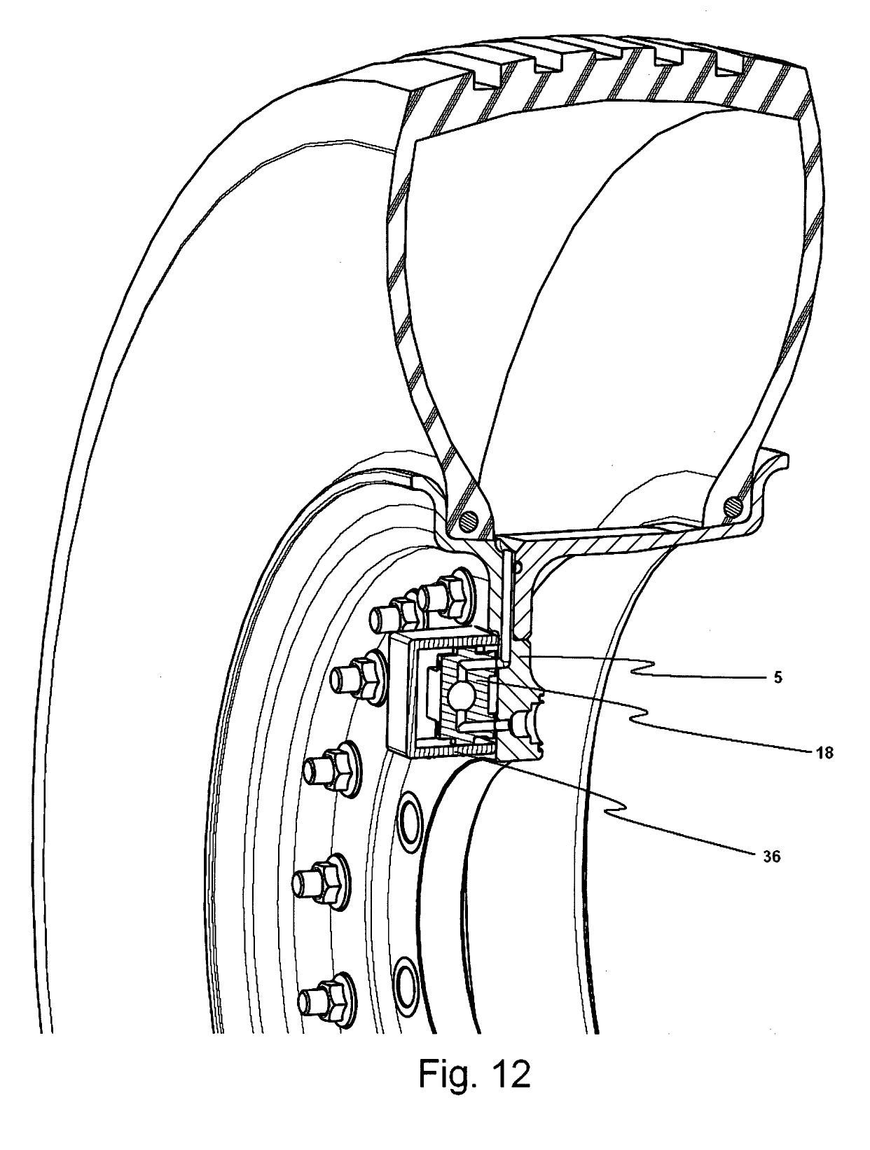

FIGS. 10, 11 and 12 also show different modes of implementing our invention. FIG. 10 shows a rim flange 34 that is itself made itself of ballistic resistant material 25. FIG. 11 shows a ballistic resistant material 25 mounted to the disc area 5 of the wheel 17 in the form of a plate 35 such that it provides protection to the tire bead 12, wheel 17, CTI valve 18, fill valve 8, wheel hardware 21 and 22, hub components (not shown), air hoses (not shown), any other critical component or a combination thereof. The ballistic resistant material 25 can be affixed to the disc 5 using adhesives, mechanical fasteners, clips, pressure, or other means. This method of protection can be applied in sections to cover specific areas or plate 35 can be a continuous part encompassing the entire circumference of the area requiring protection (as illustrated). Finally, FIG. 12 shows a complete cover 36 formed from a ballistic resistant material used for covering and protecting a component that is part of, or attached to, the wheel such as CTI Valve 18.

Once attached to or integrated in the wheel assembly, the ballistic protection will stop, slow, fragment and/or deflect a projectile traveling toward the wheel assembly. This provides a means of reducing or eliminating ballistic damage to critical parts of the wheel/tire/hub assembly including, but not limited to, the tire bead bundle, wheel hardware (including CTI valves, manual valves, hoses, and fasteners), and hub/axle components.

However, numerous variations are possible without deviating from and/or exceeding the spirit and scope of the invention. Thus, as shown in some of the figures throughout this document, this invention can be utilized in many different wheel configurations, including but not limited to:
a. Rim profiles: Standard, meaning Tire & Rim Association (TRA), European Type & Rim Technical Organisation (ETRTO), etc. and non-standard rim profiles can be used with the invention.
b. Wheel Material: This invention can be utilized on wheels of any material or material combination including, but not limited to, aluminum, steel, titanium, composites, etc.
c. Multi-piece Rims: The application of this invention extends to use on both single-piece and multi-piece rims.
d. Areas of Protection: This invention can be implemented to protect from ballistic attack both the flange area and disc area of the wheel either independently or simultaneously.
e. Rim Flanges: This invention can be implemented on either or both rim flanges or wheel halves.

Finally, the following parts list for the drawing figures may be found to be of assistance in understanding more fully the concepts of our invention:
1 1-Piece Wheel Assembly
2 1-Piece Wheel
3 Tire
4 Rim Portion of a Wheel
5 Disc Portion of a Wheel
6 Drop Center Area of a Rim
7 Rim Flange Portion of a Rim
8 Fill Valve
9 Mounting Holes of a Wheel
10 Hub Bore Area of a Wheel
11 Tire Bead
12 Tire Bead Bundle
13 Tire Sidewall
14 Tire Tread
15 Chamber
16 2-Piece Wheel Assembly
17 2-Piece Wheel
18 CTI Valve
19 Inner Rim
20 Outer Rim
21 Stud
22 Nut
23 Hub-Side CTI Airway
24 Tire-Side CTI Airway
25 Ballistic Resistant Material
26 Ballistic Resistant Material in the form of a Ring
27 Ring Fasteners
28 Modified Rim Flange Profile (FIGS. 5 and 6)
29 Ballistic Resistant Material in the form of Split Ring
30 Split Ring Protrusion
31 Modified Rim Flange (FIG. 8)
32 Ballistic Resistant Fabric
33 Rubber Lining
34 Modified Rim Flange (FIG. 9)
35 Ballistic Resistant Material in the form of a Plate
36 Ballistic Resistant CTI Valve Cover

Thus, as the foregoing makes clear, our invention generally comprehends all systems where ballistic resistant materials and functionality are integrated into or provided over a wheel. In addition, as the foregoing should also make clear, numerous variations can be made without exceeding the inventive concept. Moreover, various of the above-disclosed and other features and functions, or alternatives thereof, may be desirably combined into many other different systems or applications. Also, various presently unforeseen or unanticipated alternatives, modifications, variations or improvements therein may be subsequently made, by those skilled in the art which are also intended to be encompassed by the claims that follow.

What is claimed is:

1. A wheel with ballistic resistant material, comprising:
a circular wheel rim having formed coaxially on opposite ends thereof outwardly flaring circumferential flange sections disposed to be engaged by the beads of a tubeless tire mounted on the rim;
wherein said wheel rim has intermediate said opposite ends thereof a transverse wall section extending transversely of the axis of said rim, and having therethrough a central opening disposed coaxially of said axis;
wherein said wheel has outer and inner sides; and
wherein ballistic resistant material at least one of forms a portion of said wheel, and covers a portion of said wheel.

2. The wheel described in claim 1, wherein said ballistic resistant material covers a portion of said wheel, and is disposed adjacent at least a portion of the flange of the wheel.

3. The wheel described in claim 2, wherein said ballistic resistant material is disposed at least one of adjacent an outer side of said flange portion and adjacent an inner side of said flange portion.

4. The wheel described in claim 2, wherein said ballistic resistant material is located so as to protect at least a portion of the beads of said tubeless tire.

5. The wheel described in claim 2, wherein said ballistic resistant material forms a continuous ring adjacent the flange.

6. The wheel described in claim 2, wherein said flange has extensions at least partially surrounding said ballistic resistant material.

7. The wheel described in claim 5, wherein said continuous ring is split into parts with protrusions for linking said parts.

8. The wheel described in claim 3, wherein said ballistic resistant material is adjacent an inner side of said flange portion intermediate said flange and the tire bead.

9. The wheel described in claim 8, wherein said ballistic resistant material is a ballistic resistant fabric located intermediate said tire bead and at least one of said rim and said flange.

10. The wheel described in claim 9, where said ballistic resistant material includes a sealing material for maintaining an air-tight seal between the tire bead and at least one of said rim and said flange.

11. The wheel described in claim 1, wherein said ballistic resistant material forms a cover over a tire inflation valve located on said wheel.

12. The wheel described in claim 1, wherein said ballistic resistant material forms a portion of said wheel, said portion including at least the flange of said wheel.

13. The wheel described in claim 2, wherein said ballistic resistant material forms a substantially continuous disc mounted to and within said flange.

14. A wheel with ballistic resistant material, comprising:
a circular wheel rim having formed coaxially on opposite ends thereof outwardly flaring circumferential flange sections disposed to be engaged by the beads of a tubeless tire mounted on the rim;
wherein said wheel rim has intermediate said opposite ends thereof a transverse wall section extending transversely of the axis of said rim, and having therethrough a central opening disposed coaxially of said axis;
wherein said wheel has outer and inner sides; and
wherein ballistic resistant material is connected to said wheel, covers a portion of said wheel, and is disposed adjacent the flange of the wheel so as to protect the beads of said tubeless tire.

15. The wheel described in claim 14, wherein said ballistic resistant material forms a continuous ring adjacent the flange.

16. The wheel described in claim 15, wherein said flange has extensions at least partially surrounding said ballistic resistant material.

17. The wheel described in claim 14, wherein said ballistic resistant material forms a substantially continuous disc within said flange and transverse the axis of said rim.

18. The wheel described in claim 17, wherein said flange has extensions at least partially surrounding said ballistic resistant material.
